(19) United States
(12) Patent Application Publication
(10) Pub. No.: US 2023/0360074 A1
(43) Pub. Date: Nov. 9, 2023

(54) SYSTEM OF ALLOCATING AND REWARDING TO USER THROUGH VIRTUAL SPACE ALLOCATION AND PARTITION ON PHYSICAL SPACE

(71) Applicants: Myeong Hwan CHO, Gwangju-si (KR); Jung Hoon KIM, Seoul (KR)

(72) Inventors: Myeong Hwan CHO, Gwangju-si (KR); Jung Hoon KIM, Seoul (KR)

(21) Appl. No.: 18/017,501

(22) PCT Filed: Jun. 30, 2021
(86) PCT No.: PCT/KR2021/008228

§ 371 Date: Jan. 23, 2023

(30) Foreign Application Priority Data
Jul. 28, 2020 (KR) 10-2020-0093667

(51) Int. Cl. G06Q 30/0207; G06T 11/00

(52) U.S. Cl. CPC G06Q 30/0207; G06T 11/00; G06T 2200/24

(57) ABSTRACT

The present invention relates to the system of allocating and rewarding to user through virtual space allocation and partition on physical space. The system discloses an imaging unit that receives physical space information and creates and divides virtual spaces in the physical space; an addressing unit that allocates addresses to each of the virtual spaces divided from the imaging unit; a supplying unit that allows users to select each of the virtual spaces; and a rewarding unit that provides an event generated from the physical space to overlap the virtual space and compensates the user according to the occurrence of a valid event.

### TECHNICAL FIELD

The present invention relates to a system of allocating and rewarding to user through virtual space allocation and partition on physical space. More specifically, it is a technical field related to a system that creates a virtual space on top of a physical space, overlaps an event occurring in the physical space with the virtual space, allocates it to users and provides compensation to users according to the occurrence of an effective event.

### BACKGROUND

Recently, mixed reality (MR) is newly emerging following virtual reality (VR) and augmented reality (MR).

Mixed reality literally means a reality created by mixing various methods, and refers to creating a new environment or new information by combining the virtual world and the real world. In particular, we use the concept of mixed reality to collectively refer to all methods that can interact in real time between what exists in reality and what exists in virtual reality.

Mixed reality includes virtual reality and augmented reality, and by mixing real space and virtual space, it is possible to construct a new space in which real objects and virtual objects exchange influence in real time.

In addition, mixed reality is a reality created by mixing various methods that can exist between reality and virtual reality, and it helps to solve the limitations of imagination that did not communicate well with others.

Mixed reality is less immersive than virtual reality, but it is easy to simulate, so it is advantageous when conducting risky experiments or expressing things that require understanding of certain situations. In addition, virtual reality requires a headset device such as an HMD, and augmented reality requires a medium such as a smart phone, but mixed reality has the advantage of being able to experience without any intermediate medium, just like watching a movie.

As an example of the prior arts related to this, there is a relay service system for virtual reality based electronic sports (Korean Patent No. 10-1929504, the prior art1).

Prior art 1 relates to a relay service system for virtual reality-based electronic sports, and more particularly, it relays and broadcasts the game video to the terminal of the spectator who watches the game video provided from the game server that executes the game by communicating with the terminal of the participant participating in the virtual reality-based game, which is an electronic sport. It is about a relay service system for sports which provides game images corresponding to the viewpoint designated by the spectator in 3D at the request of the spectator and at the same time supports the viewer to freely set the viewpoint in the virtual space of the game, thereby increasing the sense of immersion in game viewing.

As an example of another prior art, there is an augmented reality based dynamic service providing method and apparatus (Korean Patent No. 10-2016-0112898, the prior art 2).

The prior art 2 comprises, if the authoring mode for supporting the viewing point-based information providing service is executed when performing the service for providing augmented reality-based content service, a process of the data related to the preset authoring item based on the predetermined viewing point in the content to be guided, a process of rendering data for each copyright item collected based on a preset augmented reality content service policy, matching it with meta data corresponding to the viewing time, and storing it, a process of checking meta data at the time of viewing the content displayed in the viewing area for each preset cycle based on the user's state information sensed when the viewer mode is executed, and as a result of the check, a process of matching and augmenting the meta data with the contents displayed in the viewing area if it matches the meta data for each viewing point corresponding to the corresponding content. The system is characterized in that content is a real three-dimensional space or virtual reality space based on a predetermined scenario viewed according to the user's movement.

As the third example of the prior arts, there is a method of providing sports relay service (Korean Patent No. 10-2017-0086203, the prior art 3).

The prior art 3 provides a sports relay service providing method, and includes a process of mapping and storing at least one coordinate that is an installation location of at least one VR (Virtual Reality) camera and an identifier of at least one VR camera, a process of collecting from at least one VR camera, photographing data of a sports field in a sports spectator seat, which is an installation location of at least one VR camera, together with an identifier of at least one VR camera, a process of classifying the collected shooting data by at least one coordinate mapped to the identifier, and generating sports relay content based on the shooting radius of at least one VR camera, a process of checking a viewing seat included in the viewing event when a viewing event of sports relay content generated from a user terminal is received, a process of Transmitting the sports relay content captured by the VR camera pre-stored and mapped to the spectator seat to the user terminal, and a process of outputting sports relay content from the user terminal to correspond to the eye tracking data, when eye tracking data is transmitted from a head mounted display (HMD) synchronized with the user terminal to the user terminal.

As the last example of the prior arts, there is a virtual reality viewing method and a virtual reality viewing system (Korean Patent No. 10-2084970, the prior art 4).

The invention of prior art 4 relates to a virtual reality viewing method and a virtual reality viewing system, including a process of receiving, by a VR providing server, a selection of one viewing position from among a plurality of viewing positions, a process of receiving, by a VR providing server, one or more VR images captured at each of a plurality of viewing locations in real time, and a process of transmitting, by a VR providing server, one or more real-time VR images corresponding to a selected viewing position among a plurality of viewing positions to a VR terminal.

### SUMMARY OF INVENTION

The present invention relates to the system of allocating and rewarding to user through virtual space allocation and partition on physical space.

First, the present invention is to create a virtual space on top of a physical space that actually exists.

Second, the present invention is to divide the created virtual space, allocate addresses, and provide the divided virtual space to the user.

Third, the invention is to overlap an event actually occurring in a physical space with a virtual space.

The object of the present invention is not limited by the features described above, and other unmentioned tasks to solve should be clearly understood by the skilled artisan with the details below.

### Technical Solution

According to the present invention, the system of allocating and rewarding to user through virtual space allocation and partition on physical space has the following problem solving means for the above problem to be solved.

According to the present invention, the system comprises an imaging unit that receives physical space information and creates and divides virtual spaces in the physical space; an addressing unit that allocates addresses to each of the virtual spaces divided from the imaging unit; a supplying unit that allows users to select each of the virtual spaces; and a rewarding unit that provides an event generated from the physical space to overlap the virtual space and compensates the user according to the occurrence of a valid event.

According to the present invention, the system further comprises the imaging unit including a scan part that extracts and receives information of the physical space; a build part selectively creating the virtual space on the physical space input from the scan part; and a partition part configured to arbitrarily partition and divide the virtual space created by the build part to designate a plurality of seating zones. According to the present invention, the system further comprises the addressing unit including a grade part that assigns a predetermined grade to each of the plurality of seating zones according to preset standard; and an address part for allocating an arbitrary address to each of the plurality of seating zones.

According to the present invention, the system further comprises the address part including a sorting part for arranging the plurality of seating zones according to the predetermined grade; and a numbering part for assigning individual numbers to the plurality of seating zones aligned from the sorting part.

According to the present invention, the system further comprises the supplying unit including a content part which retrieves information on the plurality of seating zones to which addresses are assigned from the addressing unit and provides information on the plurality of seating zones; a user selecting part for allowing the user to select at least one seating zone among the plurality of seating zones; and a sharing part providing a user seating zone in which the user can exercise the user's right to occupy the seating zone when the user selects the seating zone.

According to the present invention, the system further comprises the content part including a preview part providing preview contents for the plurality of seating zones; and an expecting part that calculates and presents probability data of occurrence of the valid event from the seating zone that the user wants to select.

According to the present invention, the system comprises the user's right to occupy which is valid from the time when the event occurs in the user seating zone, and is terminated when the event ends.

According to the present invention, the system further comprises the rewarding unit including an overlap part for overlapping the event occurring in the physical space with the user seating zone; and a reward part for compensating the user for the valid event when the valid event occurs in the user seating zone selected by the user.

According to the present invention, the system further comprises the overlap part including a collecting part that loads the physical space in real time and selectively collects the event generated from the physical space; a copy part equally copies the events collected from the collecting part to the virtual space; and a rendering part which renders the event copied from the copy part to the seating zone.

According to the present invention, the system comprises the rewarding part arranging the valid event items and providing different rewards according to the type of the valid event.

### Effects of Invention

According to the present invention, system of allocating and rewarding to user through virtual space allocation and partition on physical space provides effects as follows.

First, the present invention is to allow a virtual space to be selectively created on top of an actually existing physical space to be partitioned and divided arbitrarily.

Second, the present invention is to assign a predetermined rank to a plurality of seating zones and allow individual addresses to be assigned to each seating zone.

Third, the present invention is to allow an event actually occurring in a physical space to be equally overlapped in a virtual space.

Fourth, the present invention is to provide compensation for valid events when a valid event occurs in the virtual space allocated to the user.

The effect of the present invention is not limited thereto, and other effects unmentioned will be apparently considered by the skilled artisan as follows.

### BRIEF DESCRIPTION OF DRAWINGS

FIG. 1 is a conceptual diagram of the system of allocating and rewarding to user through virtual space allocation and partition on physical space according to an embodiment of the present invention.

FIG. 2 is a block diagram of an imaging unit of the system of allocating and rewarding to user through virtual space allocation and partition on physical space according to an embodiment of the present invention.

FIG. 3 is a conceptual diagram of a scan part of the system of allocating and rewarding to user through virtual space allocation and partition on physical space according to an embodiment of the present invention.

FIG. 4 is a conceptual diagram of a partition part of the system of allocating and rewarding to user through virtual space allocation and partition on physical space according to an embodiment of the present invention.

FIG. 5 is a block diagram of an addressing unit of the system of allocating and rewarding to user through virtual space allocation and partition on physical space according to an embodiment of the present invention.

FIG. 6 is a conceptual diagram of a grade part the system of allocating and rewarding to user through virtual space allocation and partition on physical space according to an embodiment of the present invention.

FIG. 7 is a conceptual diagram of an address part of the system of allocating and rewarding to user through virtual space allocation and partition on physical space according to an embodiment of the present invention.

FIG. 8 is a block diagram of a supplying unit of the system of allocating and rewarding to user through virtual space allocation and partition on physical space according to an embodiment of the present invention.

FIG. 9 is a conceptual diagram of a user selecting part of the system of allocating and rewarding to user through virtual space allocation and partition on physical space according to an embodiment of the present invention.

FIG. 10 is a conceptual diagram of a sharing part of the system of allocating and rewarding to user through virtual space allocation and partition on physical space according to an embodiment of the present invention.

FIG. 11 is a block diagram of a rewarding unit of the system of allocating and rewarding to user through virtual space allocation and partition on physical space according to an embodiment of the present invention.

FIG. 12 is a conceptual diagram of an overlap of the system of allocating and rewarding to user through virtual space allocation and partition on physical space according to an embodiment of the present invention.

FIG. 13 is a conceptual diagram of a reward part of the system of allocating and rewarding to user through virtual space allocation and partition on physical space according to an embodiment of the present invention.

### DETAILED DESCRIPTION OF THE INVENTION

According to the present invention, the system of allocating and rewarding to user through virtual space allocation and partition on physical space can make various changes and have various embodiments, and specific embodiments will be illustrated in the drawings and described in detail in the detailed description. However, this is not intended to limit the present invention to specific embodiments, and should be understood to include all modifications, equivalents, or substitutes included in the technical spirit and scope of the present invention.

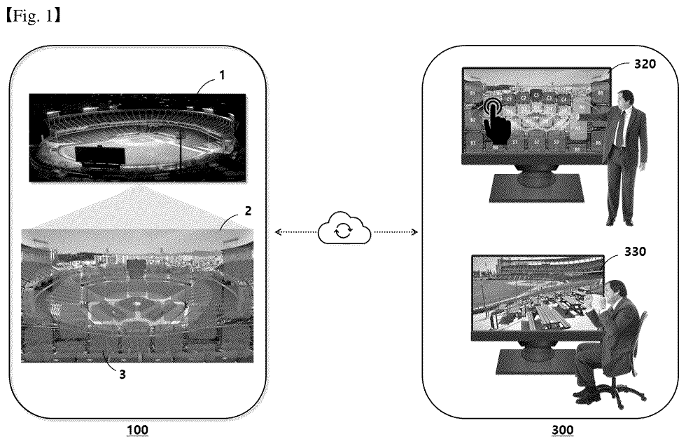

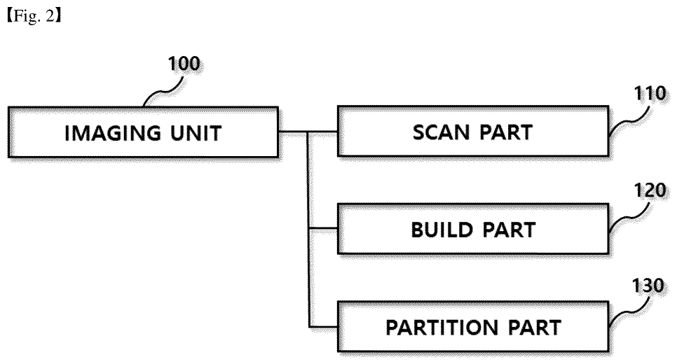

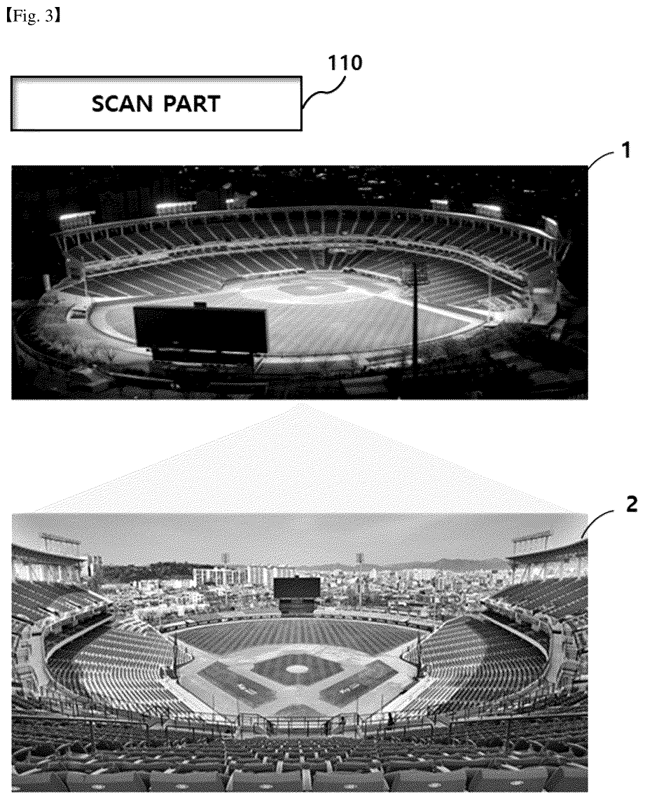

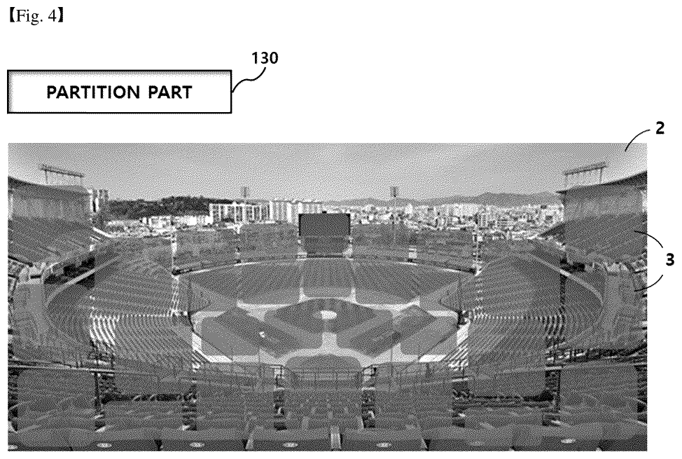

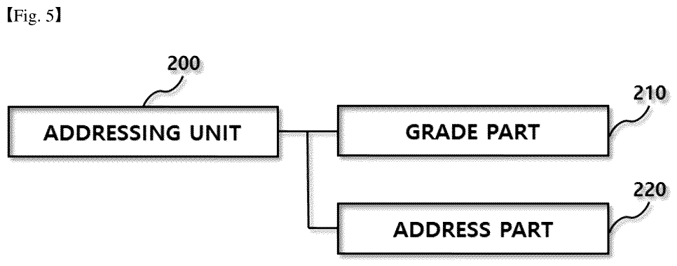

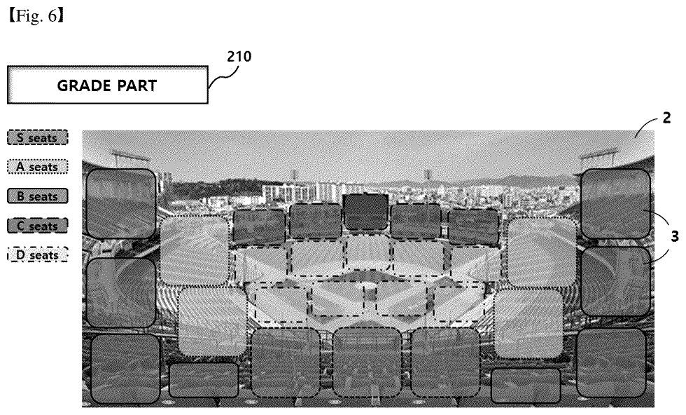

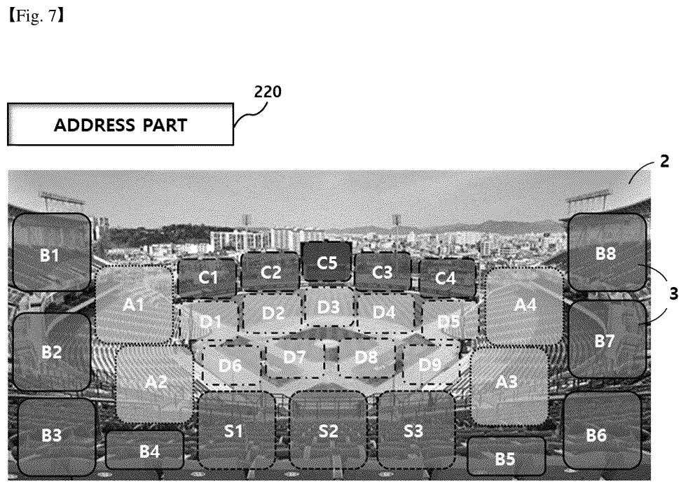

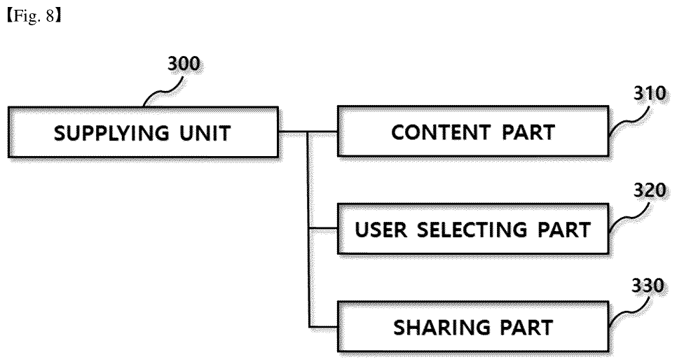

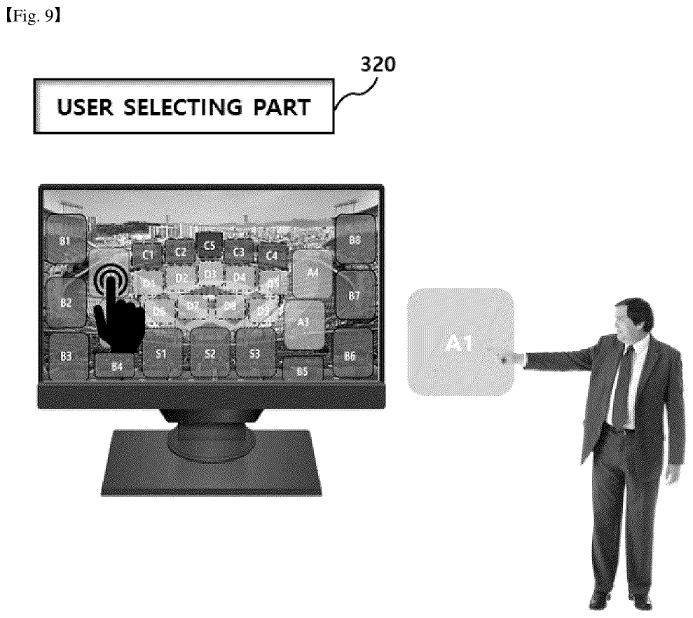

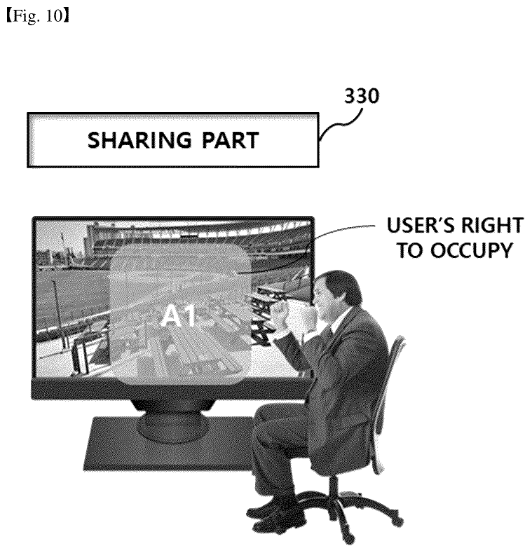

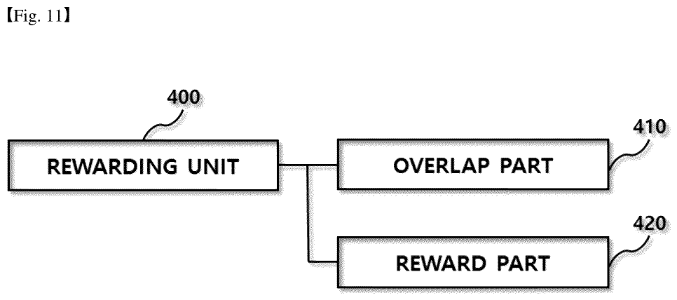

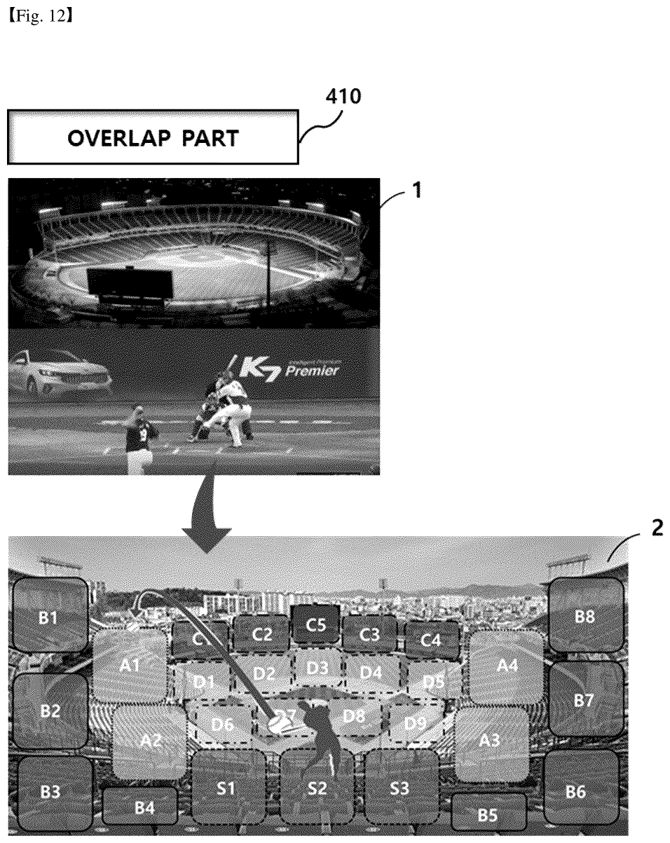

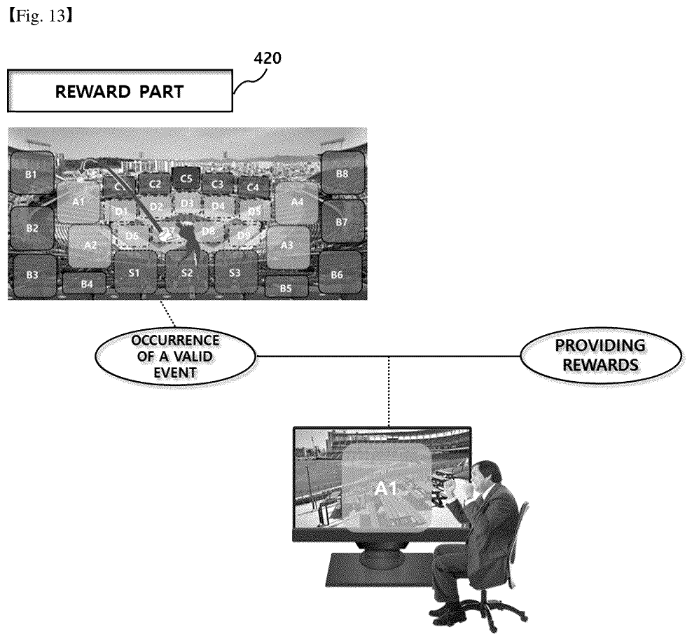

FIG. 1 is a conceptual diagram of the system of allocating and rewarding to user through virtual space allocation and partition on physical space according to an embodiment of the present invention. FIG. 2 is a block diagram of an imaging unit of the system of allocating and rewarding to user through virtual space allocation and partition on physical space according to an embodiment of the present invention. FIG. 3 is a conceptual diagram of a scan part of the system of allocating and rewarding to user through virtual space allocation and partition on physical space according to an embodiment of the present invention. FIG. 4 is a conceptual diagram of a partition part of the system of allocating and rewarding to user through virtual space allocation and partition on physical space according to an embodiment of the present invention. FIG. 5 is a block diagram of an addressing unit of the system of allocating and rewarding to user through virtual space allocation and partition on physical space according to an embodiment of the present invention. FIG. 6 is a conceptual diagram of a grade part the system of allocating and rewarding to user through virtual space allocation and partition on physical space according to an embodiment of the present invention. FIG. 7 is a conceptual diagram of an address part of the system of allocating and rewarding to user through virtual space allocation and partition on physical space according to an embodiment of the present invention. FIG. 8 is a block diagram of a supplying unit of the system of allocating and rewarding to user through virtual space allocation and partition on physical space according to an embodiment of the present invention. FIG. 9 is a conceptual diagram of a user selecting part of the system of allocating and rewarding to user through virtual space allocation and partition on physical space according to an embodiment of the present invention. FIG. 10 is a conceptual diagram of a sharing part of the system of allocating and rewarding to user through virtual space allocation and partition on physical space according to an embodiment of the present invention. FIG. 11 is a block diagram of a rewarding unit of the system of allocating and rewarding to user through virtual space allocation and partition on physical space according to an embodiment of the present invention. FIG. 12 is a conceptual diagram of an overlap of the system of allocating and rewarding to user through virtual space allocation and partition on physical space according to an embodiment of the present invention. FIG. 13 is a conceptual diagram of a reward part of the system of allocating and rewarding to user through virtual space allocation and partition on physical space according to an embodiment of the present invention.

According to the present invention, the system of allocating and rewarding to user through virtual space allocation and partition on physical space creates a virtual space 2 on the physical space 1 to overlap events occurring on the physical space 1 with the virtual space 2 and allocates them to user, and discloses a technical idea that provides tangible or intangible rewards to users according to the occurrence of valid events.

In general, the physical space 1 refers to all real spaces in which certain substances or objects actually exist, and for example, a stadium in which various sports games are held may be defined as the physical space 1.

In addition, events occurring on the physical space 1 may include all situations and variables that may occur in the stadium. For example, if the physical space 1 is a baseball field, the baseball game itself becomes an event, and valid events that may occur in the baseball field include hits, runs, ground balls, fly balls, bunts, home runs, fouls, and sacrifices. It is preferred to include at least one of fly or strikeout.

According to the present invention, the system of allocating and rewarding to user through virtual space allocation and partition on physical space overlaps all events that actually occur in the virtual space 2, allocates the overlapped virtual space 2 to the user, and when a valid event occurs in the virtual space 2 allocated to the user, appropriate compensation may be provided to the user.

According to the present invention, the system of allocating and rewarding to user through virtual space allocation and partition on physical space comprises an imaging unit 100, an addressing unit 200, a supplying unit 300 and a rewarding unit 400 as shown in FIG. 1.

First, the imaging unit 100 is configured to receive information of the physical space 1, and generate and divide the virtual space 2 in the physical space 1.

The imaging unit 100 receives the above-described information of the real space that actually exists, and the information of the real space may be provided by an external server.

The external server may be a relay broadcasting station or a relay center that relays sports games, and all information of the stadium can be provided from the server in real time.

According to the present invention, the imaging unit 100 of the system of allocating and rewarding to user through virtual space allocation and partition on physical space includes a scan part 110, a build part 120, and a partition part 130 as shown in FIG. 2.

First, as shown in FIG. 3, the scan part 110 extracts and receives information of the physical space 1.

The scan part 110 extracts all information of a stadium where a sports game is held. Stadium information extracts at least one of stadium structure, size, area, field information in which a game is played, game information, seating chart, or dugout information.

The build part 120 selectively creates a virtual space 2 on the physical space 1 input from the scan part 110.

The build part 120 creates a physical space 1 input from the scan part 110, that is, a virtual space 2 above the stadium. In addition, the build part 120 creates a virtual space 2 in all spaces of the stadium. Preferably, the virtual space 2 is formed in all spaces of the stadium where valid events can occur.

As shown in FIG. 4, the partition part 130 arbitrarily partitions and divides the virtual space 2 created by the build part 120 to designate a plurality of seating zones 3.

The partition part 130 arbitrarily partitions and divides the virtual space 2 formed over stadium facilities and fields such as spectator seats and electronic signboards, created from the build part 120.

Areas divided from the partition part 130 are referred to as a plurality of seating zones 3. The seating zone 3 of the virtual space 2 can be designated in all spaces of the stadium regardless of the seats in the physical space 1. N seating zones 3 can exist and it is preferable not to limit the number of the seating zone.

The addressing unit 200 allocates an address to each virtual space 2 divided from the imaging unit 100.

The addressing unit 200 sets a unique address for each of the plurality of seating zones 3 divided from the partition part 130.

According to the present invention, the addressing unit 200 of the system comprises a grade part 210 and an address part 220 as shown in FIG. 5.

First, as shown in FIG. 6, the grade part 210 assigns a predetermined grade to each of the plurality of seating zones 3 according to a preset standard.

As shown in FIG. 6, the grade part 210 may set a predetermined grade to S, A, B, or C, and it is preferable to set the predetermined grade to a higher grade as it is closer to the field of the stadium, which is the physical space 1.

As shown in FIG. 7, the address part 220 assigns an arbitrary address to each of the plurality of seating zones 3.

The address part 220 includes a sorting part 221 and a numbering part 222.

The sorting part 221 arranges the plurality of seating zones 3 according to a predetermined rank.

The sorting part 221 is able to sequentially sort from a higher class among the predetermined grades set by the grade part 210.

For example, as shown in FIG. 6, the plurality of seating zones 3 may be arranged in the order of S seats, A seats, B seats, and C seats close to the field.

The numbering part 222 assigns individual numbers to the plurality of seating zones 3 aligned from the sorting part 221. The numbering part 222 may designate individual unique numbers to each of the S seats, A seats, B seats, and C seats arranged from the sorting part 221.

As shown in FIG. 7, the numbering part 222 is able to assign addresses to a plurality of seating zones 3 by designating individual numbers for each grade of S1, S2, S3, A1, A2, A3, A4, B1, B2, . . . C3 and C4.

The supplying unit 300 provides the user with the ability to select each virtual space 2.

The supplying unit 300 may provide information about a plurality of divided seating zones 3 to the user.

According to the present invention, the supplying unit 300 of the system includes a contents part 310, a user-selecting part 320 and a sharing part 330, as shown in FIG. 8.

First, the content part 310 retrieves information on a plurality of seating zones 3 to which addresses are assigned from the addressing unit 200 and provides information on the plurality of seating zones 3.

In addition, the content part 310 presents event information and information on a plurality of seating zones 3 to users in real time through real-time relay, binary relay, YouTube, a portal site, and the like.

The event information presented by the content part 310 relates to game information in the physical space 1. When the physical space 1 is a baseball field, at least one information of a baseball field where a game is played, a starting lineup of the home team and an away team, an opponent's record, individual scores of starting pitchers and other lines, or season scores is provided.

In addition, the content part 310 provides location information and address information of the plurality of seating zones 3 in the virtual space 2.

The content part 310 includes a preview part 311 and an expecting part 312.

The preview part 311 provides preview contents for a plurality of seating zones 3.

When a user selects one seating zone 3 from among a plurality of seating zones 3, the preview part 311 presents content for previewing an event in the corresponding seating zone 3.

The expecting part 312 calculates and presents probability data for an effective event to occur from the seating zone 3 that the user wants to select.

The expecting part 312's presenting data on the probability of occurrence of at least one of a hit, a score, a ground ball, a fly ball, a bunt, a home run, a foul, a sacrifice fly, or a strikeout among valid events in the seating zone 3 that the user wants to select possibly helps the user in selecting a seating zone 3.

As shown in FIG. 9, the user selecting part 320 allows a user to select at least one seating zone 3 from among a plurality of seating zones 3.

In the user selecting part 320, the user can select the seating zone 3 having a high probability of occurrence of a valid event by referring to the preview content and probability data provided from the content part 310.

As shown in FIG. 10, the sharing part 330 provides a user seating zone 4 where the user can exercise the user's right to occupy the seating zone 3 when the user selects the seating zone 3.

The sharing part 330 charges the user a fee for the seating zone 3 selected by the user selecting part 320 and it is preferable to charge the user for the seating zone 3 and to provide the user seating zone 4 so that the user can exercise the user's right to occupy when the user pays the fee for the seating zone 3.

In the sharing part 330, the user can select the seating zone 3 from before the start of the game to the end of the game and exercise the user's right to occupy from the time the user's selection is completed.

However, considering the delay time caused by the media where the game is relayed and the safety factor for the network processing time when the billing and payment for the seating zone 3 selected by the user is completed, after a certain time, it is desirable for the user to exercise the user's right to occupy.

The user's right to occupy is valid from the time an event occurs in the user seating zone 4, and is terminated when the event ends.

For example, the start of the game is regarded as the start of the event, and the moment the game ends, the event is considered to end. Therefore, in the case of the user's right to occupy, it is effective only during the event, and it is preferable that the user's right to occupy is automatically revoked when the event ends.

If the user has the user's right to occupy during the game, it is desirable that the user's right to occupy is valid from the moment the right is selected to the moment the game ends. Therefore, compensation for a valid event occurring before the user selects the user's right to occupy is not provided.

The rewarding unit 400 overlaps an event generated from the physical space 1 with the virtual space 2 and compensates the user according to the occurrence of a valid event.

According to the present invention, as shown in FIG. 11, the rewarding unit 400 of the system includes an overlap part 410 and a reward part 420.

As shown in FIG. 12, the overlap part 410 overlaps events occurring in the physical space 1 with the user seating zone 4. The overlap part 410 includes a collecting part 411, a copy part 412 and a rendering part 413.

First, the collecting part 411 loads the physical space 1 in real time and selectively collects events generated from the physical space 1.

The copy part 412 identically copies events collected by the collecting part 411 to the virtual space 2.

The rendering part 413 renders the event copied from the copy part 412 to the seating zone 3.

The rendering part 413 renders the user seating zone 4 selected by the user to present a valid event to the user.

As shown in FIG. 13, the reward part 420 provides a reward for the valid event to the user when a valid event occurs in the user seating zone 4 selected by the user.

The reward part 420 sorts valid event items, and different rewards are provided according to types of valid events.

For example, during a valid event, when a foul ball flies into the user seating zone 4, the user can be rewarded with an actual foul ball, rewarded with a signed ball of the player who hit the foul ball, or presented with a reward for the valid event through a predetermined prize money. In addition, it is preferable to present different rewards depending on the type of event, such as when a foul ball flies out of an effective event and when a home run ball flies out.

The scope of the rights of the present invention is determined by the matters described in the claims. In addition, parentheses used in the claims are not written for selective limitation, but are used for clear components, and descriptions in parentheses should also be interpreted as essential components.

What is claimed is:

1. A system of allocating and rewarding to user through virtual space allocation and partition on physical space characterized in that it comprises,
an imaging unit that receives physical space information and creates and divides virtual spaces in the physical space;
an addressing unit that allocates addresses to each of the virtual spaces divided from the imaging unit;
a supplying unit that allows users to select each of the virtual spaces; and
a rewarding unit that provides an event generated from the physical space to overlap the virtual space and compensates the user according to the occurrence of a valid event.

2. The system of claim 1, wherein the imaging unit comprises,
a scan part that extracts and receives information of the physical space;
a build part selectively creating the virtual space on the physical space input from the scan part; and
a partition part configured to arbitrarily partition and divide the virtual space created by the build part to designate a plurality of seating zones.

3. The system of claim 2, wherein the addressing unit comprises,
a grade part that assigns a predetermined grade to each of the plurality of seating zones according to preset standard; and,
an address part for allocating an arbitrary address to each of the plurality of seating zones.

4. The system of claim 3, wherein the address part comprises,
a sorting part for arranging the plurality of seating zones according to the predetermined grade; and
a numbering part for assigning individual numbers to the plurality of seating zones aligned from the sorting part.

5. The system of claim 3, wherein the supplying unit comprises,
a content part which retrieves information on the plurality of seating zones to which addresses are assigned from the addressing unit and provides information on the plurality of seating zones;
a user selecting part for allowing the user to select at least one seating zone among the plurality of seating zones; and,
a sharing part providing a user seating zone in which the user can exercise the user's right to occupy the seating zone when the user selects the seating zone.

6. The system of claim 5, wherein the content part comprises,
a preview part providing preview contents for the plurality of seating zones; and
an expecting part that calculates and presents probability data of occurrence of the valid event from the seating zone that the user wants to select.

7. The system of claim 5, wherein the user's right to occupy is valid from the time when the event occurs in the user seating zone, and is terminated when the event ends.

8. The system of claim 5, wherein the rewarding unit comprises,
an overlap part for overlapping the event occurring in the physical space with the user seating zone; and
a reward part for compensating the user for the valid event when the valid event occurs in the user seating zone selected by the user.

9. The system of claim 8, wherein the overlap part comprises,
a collecting part that loads the physical space in real time and selectively collects the event generated from the physical space;
a copy part equally copies the events collected from the collecting part to the virtual space; and
a rendering part which renders the event copied from the copy part to the seating zone.

10. The system of claim 8, wherein the reward part arranges the valid event items and provide different rewards according to the type of the valid event.
